(19) United States
(12) Patent Application Publication
(10) Pub. No.: US 2025/0144867 A1
(43) Pub. Date: May 8, 2025

(54) Cluster of Polymeric Columns and Method of Making Same

(71) Applicant: 3M INNOVATIVE PROPERTIES COMPANY, St. Paul, MN (US)

(72) Inventors: Andrew C. Clausen, St. Paul, MN (US); Li Yu, Santa Clara, CA (US); Michael R. Berrigan, Oakdale, MN (US); Samuel E. Marmon, Gallatin, TN (US); Timothy J. Lindquist, Woodbury, MN (US); William J. Kopecky, Hudson, WI (US)

(21) Appl. No.: 18/835,283

(22) PCT Filed: Feb. 3, 2023
(86) PCT No.: PCT/IB2023/050996

§ 371 Date: Aug. 1, 2024

Related U.S. Application Data
(60) Provisional application No. 63/310,197, filed on Feb. 15, 2022.

(51) Int. Cl. B29C 48/16; B29C 48/06

(52) U.S. Cl. CPC B29C 48/16; B29C 48/06

(57) ABSTRACT

A polygonal cluster includes a plurality of substantially parallel polymeric columns disposed inside an outermost polygonal perimeter of the polygonal cluster and extending along a thickness direction between opposing first and second major surfaces of the polygonal cluster; and a common first material substantially filling regions within the polygonal perimeter between the polymeric columns and across the thickness of the polygonal cluster, such that in a cross-section of the polygonal cluster in a plane substantially orthogonal to the thickness of the cluster, for at least each of a plurality of first polymeric columns in the plurality of polymeric columns disposed adjacent the perimeter of the cluster, the first polymeric column has a pear shape having a wider portion facing the perimeter and a narrower portion facing away from the perimeter.

### SUMMARY

In some aspects, the present description provides a polygonal cluster including a plurality of substantially parallel polymeric columns disposed inside an outermost polygonal perimeter of the polygonal cluster and extending along a thickness direction between opposing first and second major surfaces of the polygonal cluster; and a common first material substantially filling regions within the polygonal perimeter between the polymeric columns and across the thickness of the polygonal cluster, such that in a cross-section of the polygonal cluster in a plane substantially orthogonal to the thickness of the cluster, for at least each of a plurality of first polymeric columns in the plurality of polymeric columns disposed adjacent the perimeter of the cluster, the first polymeric column has a pear shape having a wider portion facing the perimeter and a narrower portion facing away from the perimeter.

In some aspects, the present description provides a polygonal cluster including a plurality of substantially parallel polymeric columns embedded in, and co-extruded and substantially co-extensive in length with, a common polymeric base material. An average column viscosity of the polymeric columns is higher than an average base viscosity of the polymeric base material by at least a factor of 1.2, such that in a cross-section of the cluster in a plane substantially orthogonal to the length of the cluster, the cluster has a closed outermost polygonal perimeter and a total area A1, and the polymeric columns have a total area A2, where A2/A1≥0.5.

In some aspects, the present description provides a cluster including a plurality of substantially parallel polymeric columns extending along a length direction of the cluster and embedded in, and co-extruded and substantially co-extensive in length with, a common polymeric base material, such that in a cross-section of the cluster in a plane substantially orthogonal to the length of the cluster, the cluster has a closed outermost perimeter defining a first area A1, and a smallest polygon that has fewer than 10 sides and surrounds the plurality of polymeric columns has a second area A2, where A2/A1≥0.5.

In some aspects, the present description provides a cluster including a plurality of substantially parallel polymeric columns disposed inside an outermost perimeter of the cluster and extending along a thickness direction between opposing first and second major surfaces of the cluster; and a common first material substantially filling regions within the perimeter between the polymeric columns and across the thickness of the cluster, such that in a cross-section of the cluster in a plane substantially orthogonal to the thickness of the cluster, for at least each of a plurality of first polymeric columns in the plurality of polymeric columns disposed adjacent the perimeter of the cluster, the first polymeric column has a pear shape having a wider portion facing the perimeter and a narrower portion facing away from the perimeter. An average viscosity of the polymeric columns can be higher than an average viscosity of the first material by at least a factor of 1.2.

In some aspects, the present description provides a cluster including a plurality of substantially parallel polymeric columns disposed inside an outermost perimeter of the cluster and extending along a thickness direction between opposing first and second major surfaces of the cluster where each polymeric column includes a polymeric core surrounded by a polymeric cladding; and a common first material substantially filling regions within the perimeter between the polymeric columns and across the thickness of the cluster. For at least each of a plurality of first polymeric columns in the plurality of polymeric columns, a shape of an outer perimeter of the polymeric cladding can be substantially different than a shape of an outer perimeter of the polymeric core.

In some aspects, the present description provides a method of making a cluster. The method includes extruding a plurality of substantially round first columns including a core material along substantially a same first direction: extruding one or more second columns including a base material along the first direction; and joining the one or more second columns along the first direction. The joining causes the substantially round first columns to become substantially polygonal first columns embedded in a common matrix comprising the base material.

In some aspects, the present description provides a method of making a cluster. The method includes extruding a molten stream through a substantially round die exit opening and cooling the molten stream to provide the cluster. Extruding the molten stream includes extruding a plurality of first columns along substantially a same first direction where the plurality of first columns has a first average viscosity; and extruding a base material along the first direction where the base material substantially fills regions between the first columns and has a second average viscosity. Extruding and cooling the molten stream causes a perimeter of the cluster becomes substantially polygonal at least in part due to the first average viscosity being higher than the second average viscosity.

These and other aspects will be apparent from the following detailed description. In no event, however, should this brief summary be construed to limit the claimable subject matter.

### BRIEF DESCRIPTION OF THE DRAWINGS

FIG. 1 is a schematic cross-sectional view of a cluster of polymeric columns in a cross-section substantially parallel to a thickness direction of the cluster, according to some embodiments.

FIG. 2A is a schematic cross-sectional view of a polygonal cluster in a cross-sections substantially orthogonal to a thickness direction of the cluster, according to some embodiments.

FIG. 2B is a schematic cross-sectional view of a column having a pear shape, according to some embodiments.

FIG. 3A is a schematic cross-sectional view of a cluster having a generally round perimeter in a cross-section substantially orthogonal to a thickness direction of the cluster, according to some embodiments.

FIG. 3B is a schematic cross-sectional view of a column including a core and a cladding having substantially different shapes, according to some embodiments.

FIG. 4 is a schematic cross-sectional view of light absorbing polymeric material, according to some embodiments.

FIGS. 5A-5B are schematic plan views of portions of two plates of a die, according to some embodiments.

FIG. 5C is a schematic illustration of extruding a molten stream, according to some embodiments.

FIG. 6 is a schematic cross-sectional view of a cluster including substantially polygonal columns in a cross-section substantially orthogonal to a thickness direction of the cluster, according to some embodiments.

FIGS. 7-11 are cross-sectional views of exemplary polygonal clusters in cross-sections substantially orthogonal to a thickness or length direction of the clusters.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

According to some aspects of the present description, it has been found that clusters of polymeric columns embedded in a base material can be formed where the columns of the cluster and/or the outer perimeter of the cluster can be shaped, at least in part, due to the materials of the columns and the base material having different viscosities and/or different surface tensions. In some embodiments, the cluster is formed from extruding an island-in-sea extrudate through a round die exit hole and the different viscosities and/or surface tensions of the columns (islands) and the base material (sea), at least in part, causes a perimeter of the cluster to have a polygonal (e.g., hexagonal) shape in a cross-section orthogonal to a length of the cluster. In some such embodiments or in other embodiments, the different viscosities and/or surface tensions of the columns (islands) and the base material (sea), at least in part, causes the cross-sectional shape of at least some of the columns to have a pear shape or a polygonal shape in a cross-section orthogonal to a length of the cluster. Generally, it has been found that a viscosity of the columns being substantially greater than a viscosity of the base material (e.g., greater by at least a factor of 1.2) and having a total cross-sectional area of the columns being a substantial fraction (e.g., at least 50 percent or at least 70 percent or in another range described elsewhere herein) of a total cross-sectional area of the cluster results in a polygonal perimeter. The perimeter can be polygonal even when the exit orifice of a die used to extrude the cluster is round due, at least in part, to the higher viscosity and/or surface tension columns (islands), held closely together by lower viscosity and/or surface tension base material (sea). The shape of the polygonal perimeter can depend on the arrangement of the columns within the perimeter. For example, a hexagonal packing of the columns can result in a hexagonal perimeter.

The clusters of the present description can be used in applications where island-in-sea type fibers are used. The clusters may be used in electronics, automotive, apparel, medical, and food products. In some embodiments, the clusters are useful in optical applications. In some such embodiments, or in other embodiments, the columns of the clusters are optically transparent and the base material surrounding the columns are light absorbing. Heat and/or pressure can be applied to a plurality of such clusters to form an integral block of the columns which can be cut to provide a light control film which can be used as a privacy filter, for example.

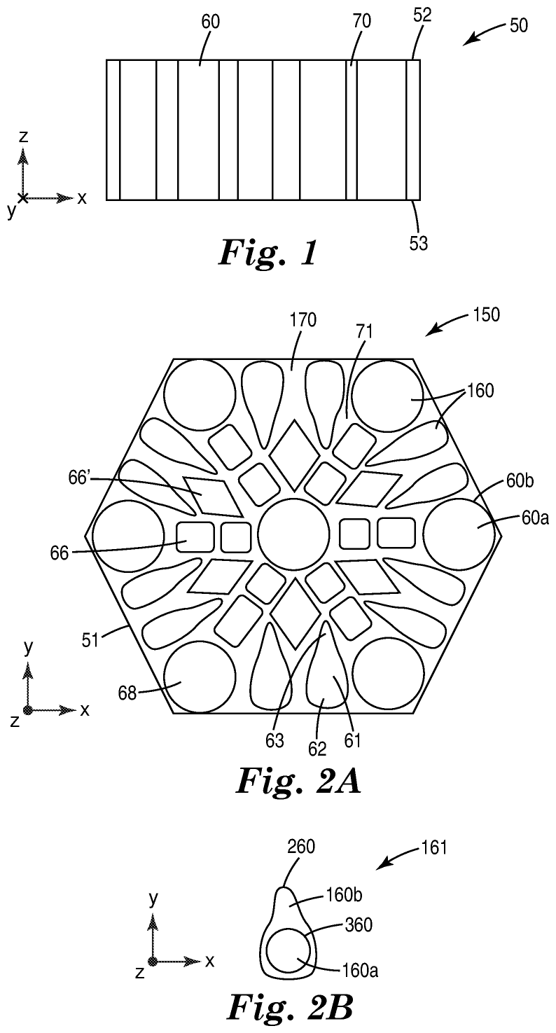

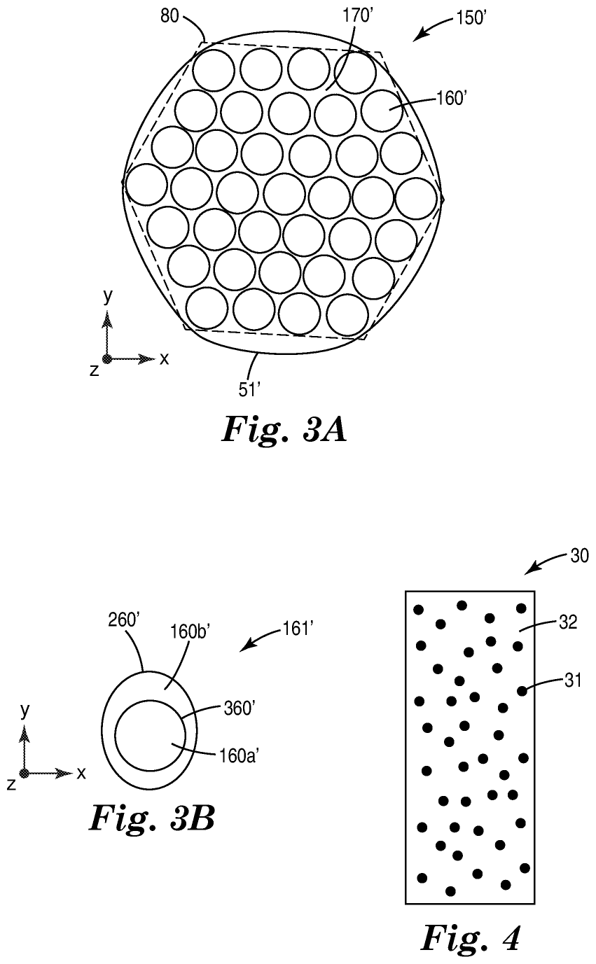

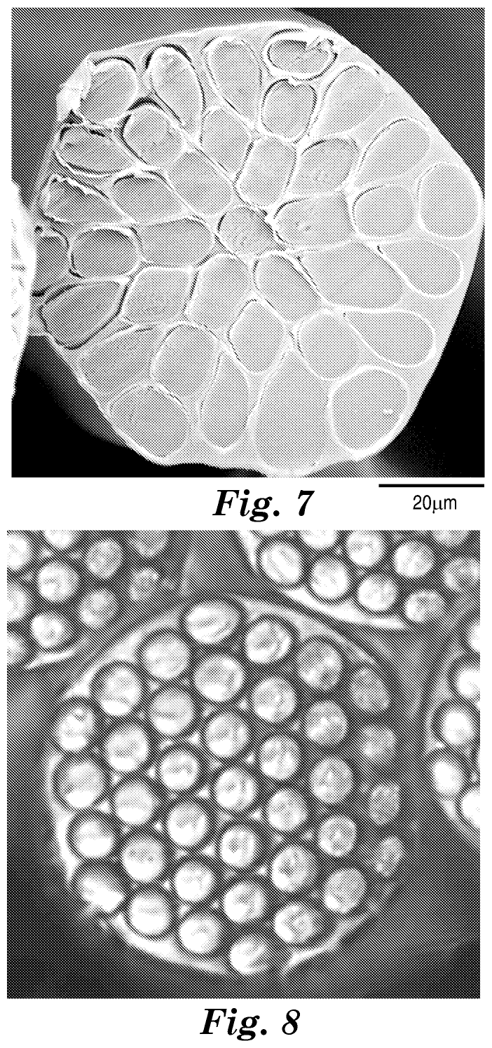

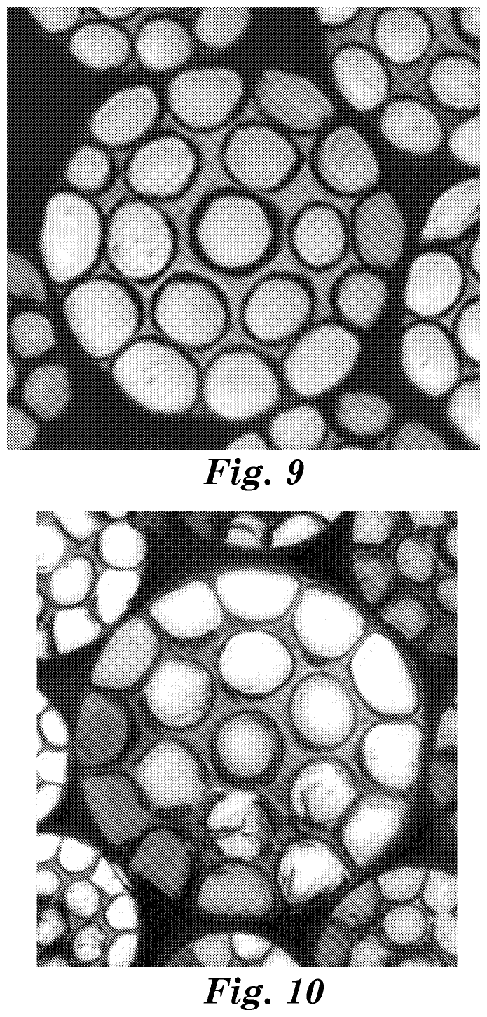

FIG. 1 is a schematic cross-sectional view of a cluster 50 of polymeric columns 60 in a cross-section substantially parallel (e.g., within about 30, 20, 10 or 5 degrees of parallel) to a thickness direction (z-direction) of the cluster, according to some embodiments. The columns 60 can be embedded in a common material 70. FIGS. 2A and 3A are schematic cross-sectional views of clusters 150 and 150′ of respective polymeric columns 160 and 160′ in cross-sections substantially orthogonal to a thickness direction (z-direction) of the cluster, according to some embodiments. FIG. 2B is a schematic cross-sectional view of a column 161 including a core 160a surrounded by a cladding 160b that may be included in a cluster 150, 150′, for example, according to some embodiments. FIG. 3B is a schematic cross-sectional view of a column 161′ including a core 160a′ surrounded by a cladding 160b′ that may be included in a cluster 150, 150′, for example, according to some embodiments. In some embodiments, the cladding substantially conforms to the core (e.g., the cladding 60b schematically illustrated in FIG. 2A substantially conforms to the core 60a schematically illustrated in FIG. 2A). In other embodiments, for at least one polymeric column in the plurality of polymeric columns (e.g., each of at least 1, 2, 3, or 4 of the polymeric columns), the polymeric column includes a polymeric core surrounded by a polymeric cladding where a shape of an outer perimeter 260, 260′ of the polymeric cladding 160b, 160b is substantially different than a shape of an outer perimeter 360, 360′ of the polymeric core 160a, 160a′ as schematically illustrated in FIGS. 2B and 3B, for example. The cladding may have a substantially different shape from the core due to deformation when the cluster is formed by extruding and cooling a molten stream, for example. In still other embodiments, the cladding may be omitted. The clusters 150, 150′ may correspond to cluster 50. The cluster 150 may be a polygonal cluster. A polygonal cluster has a substantially polygonal perimeter 51 which may include small deviations (e.g., deviations less than about 20, 10, or 5 percent of a largest diameter of the cluster) from an ideal polygon shape (see, e.g., FIGS. 7 and 9 which show polygonal clusters with substantially hexagonal perimeters). The cluster 150′ may be circular. A circular cluster has a substantially circular perimeter 51′ which may include small deviations (e.g., deviations less than about 20, 10, or 5 percent of a largest diameter of the cluster) from an ideal circle.

In some embodiments, a polygonal cluster 150 includes a plurality of substantially parallel polymeric columns 160 disposed inside an outermost polygonal perimeter 51 of the polygonal cluster and extending along a thickness direction (z-direction) between opposing first (52) and second (53) major surfaces (see, e.g., FIG. 1) of the polygonal cluster; and a common first material 170 substantially filling regions 71 within the polygonal perimeter 51 between the polymeric columns and across the thickness of the polygonal cluster (e.g., the material 170 can fill greater than 50, 70, 90, or 95 percent of a volume of the regions 71), such that in a cross-section of the polygonal cluster in a plane (xy-plane) substantially orthogonal (e.g., orthogonal or within about 30, 20, 10 or 5 degrees of orthogonal) to the thickness of the cluster, for at least each of a plurality of first polymeric columns 61 in the plurality of polymeric columns disposed adjacent the perimeter of the cluster, the first polymeric column has a pear shape having a wider portion 62 facing the perimeter and a narrower portion 63 facing away from the perimeter. The common first material may also or alternatively be referred to as a common polymeric base material. The number of pear shaped columns can be at least 2, 4, 6, or 8, for example. The number of pear shaped columns can be up to 30, 20, or 15, for example.

A pear shape is generally a gradually curved shape extending along a length direction of the pear shape and having wider and narrower portions at opposite ends of the pear shape along the length direction. The length of a pear shape along the length direction is generally greater than a width of the wider portion of the pear shape along a direction orthogonal to the length direction.

The plurality of polymeric columns 160 can include columns having shapes other than a pear shape. For example, the polymeric columns 160 can include columns 68 having a circular shape and/or columns 66 and 66′ having polygonal shapes (rectangular and diamond shapes, respectively, in the illustrated embodiment).

The columns 60, 160, 160′ can be substantially coextensive in length with one another and/or with the material 70, 70, 170′. In some embodiments, a cluster 50, 150, 150′ includes a plurality of substantially parallel polymeric columns 60, 160, 160′ extending along a length direction (z-direction) of the cluster and embedded in, and co-extruded and substantially co-extensive in length with, a common polymeric base material 70, 170, 170′. Elements extending over a length may be described as substantially coextensive with each other, or as substantially coextensive in length with each other, if greater than 50% of each element is coextensive with greater than 50% by length of each other element. In some embodiments, for at least a majority of the columns 60, 160, 160′, greater than about 60%, or greater than about 80%, or greater than about 90%, or greater than about 95% of a length of each column is coextensive with greater than about 60%, or greater than about 80%, or greater than about 90%, or greater than about 95% of a length of each other column. In some embodiments, greater than about 60%, or greater than about 80%, or greater than about 90%, or greater than about 95% of a length of the columns 60, 160, 160′ is coextensive with greater than about 60%, or greater than about 80%, or greater than about 90%, or greater than about 95% of a length of the material 70, 170, 170′.

The clusters of the present description may have a perimeter 51 that is substantially polygonal (see, e.g., FIGS. 2A, 7 and 9) or a perimeter 51′ that is substantially circular (see, e.g., FIGS. 3A, and 10-11), for example. The cluster 50, 150, 150′ may be characterized in terms of the ratio of the total area of the polymeric columns 60, 160, 160′ to the total area within an outermost polygonal perimeter 51 and/or the ratio of an area of a smallest polygon 80 that has fewer than 10 sides and surrounds the plurality of polymeric columns 160′ to the total area within an outermost polygonal perimeter 51. In some embodiments, in a cross-section of the cluster 150 in a plane (xy-plane) substantially orthogonal to the length of the cluster 150, the cluster 150 has a closed outermost polygonal perimeter 51 and a total area A1, and the polymeric columns have a total area A2, where A2/A1≥0.5, or 0.55, or 0.6, or 0.65, or 0.7, or 0.75, or 0.8. A2/A1 can be up to 0.95 or up to 0.9, for example. In some embodiments, in a cross-section of the cluster 150′ in a plane (xy-plane) substantially orthogonal to the length of the cluster, the cluster has a closed outermost perimeter 51′ defining a first area A1, and a smallest polygon 80 that has fewer than 10 sides and surrounds the plurality of polymeric columns 60′ has a second area A2′ (which may alternatively be denoted A2 where there is no confusion with the A2 described previously), where A2/A1≥0.5, or 0.55, or 0.6, or 0.65, or 0.7, or 0.75, or 0.8. A2′/A1 can be up to 1, or up to 0.95, or up to 0.9, for example. In some embodiments where A2′/A1 are in any of these ranges, the polymeric columns have a total area A2 (which may alternatively be denoted A3) and A2/A1 can be in any of the ranges described previously. In some embodiments, the cluster has a closed outermost perimeter 51′ defining a first area A1, a smallest polygon 80 that has fewer than 10 sides and surrounds the plurality of polymeric columns has a second area A2, and the plurality of polymeric columns has a total area A3, where A2/A1≥0.5 and A3/A1≥0.5, or A2/A1≥0.6 and A3/A1≥0.6, or A2/A1≥0.7 and A3/A1≥0.7, or A2/A1≥0.75 and A3/A1≥0.75, or A2/A1≥0.8 and A3/A1≥0.8. In some such embodiments, or in other embodiments, A3/A1 is at least 0.85 or at least 0.9 and can be up to about 1, for example. The polygon 80 having fewer than 10 sides can have 3 to 9 sides, or 4 to 8 sides, or 5 to 7 sides, or 6 sides, for example. The outermost polygonal perimeter 51 can have 3 to 9 sides, or 4 to 8 sides, or 5 to 7 sides, or 6 sides, for example.

In some embodiments, an average viscosity (which may be referred to as the average column viscosity) of the polymeric columns is higher than an average viscosity (which may also be referred to as the average base viscosity) of the first material (which may also be referred to as the polymeric base material) by at least a factor of 1.2, or 1.25, or 1.3, or 1.35, or 1.4, or 1.45, or 1.5, or 1.55, or 1.6, or 2, or 2.5, or 3. Any or all of the columns 60 can include a core 60a surrounded by a polymeric cladding 60b. In some embodiments, an average viscosity (which may be referred to as the average core viscosity) of the polymeric cores of the polymeric columns higher than an average viscosity (which may also be referred to as the average base viscosity) of the first material (which may also be referred to as the polymeric base material) by at least a factor of 1.2, or 1.25, or 1.3, or 1.35, or 1.4, or 1.45, or 1.5, or 1.55, or 1.6, or 2, or 2.5, or 3. The ratio of average viscosities (of columns to base material or of the cores to the base material) can be up to 50, 20, 10 or 5, for example. Each of the viscosities is a melt viscosity evaluated at a same shear rate and at a same temperature greater than a largest melting point of the polymeric cores and the first material. In some embodiments, each viscosity is determined according to the ASTM D3835-16 test standard at a shear rate of 100 s⁻¹ and at a temperature of 20° C. greater than a largest melting point of the polymeric cores and the first material. In some embodiments, an average surface tension of the polymeric columns is higher than an average surface tension of the first or base material. The ratio of the average surface tension of the polymeric columns to the average surface tension of the first or base material can be in a range of 1.05 to 3 or 1.1 to 2.5, for example. Average viscosity refers to the mean viscosity measured over representative samples of the polymeric columns or cores or the first or base material. Similarly, average surface tension refers to the mean surface tension measured over representative samples of the polymeric columns or the first or base material. The surface tension may be measured for the polymer at room temperature by measuring wetting contact angles of liquids with a known surface tension as is known in the art. Alternatively, the surface tension may be measured for the polymer melt at the same temperature described above for determining the viscosity. In this case, the surface tension can be determined using a pendant drop tensiometer, for example. In some embodiments, the average core viscosity (resp., surface tension) is the viscosity (resp., surface tension) of the polymeric cores (e.g., the polymeric cores can be formed from a homogeneous material) and the average base viscosity (resp., surface tension) is the viscosity (resp., surface tension) of the first or base material (e.g., the first or base material can be a homogeneous material). The viscosity of a column containing a core and a cladding should be understood to be the volume-average viscosity of the core and the cladding since the core and cladding typically contribute to flow properties approximately in proportion to their volumes. The surface tension of a column containing a core and a cladding should be understood to be the surface tension of the cladding since the cladding is the outer layer of the column.

In some embodiments, a cluster 150 includes a plurality of substantially parallel polymeric columns 160 disposed inside an outermost perimeter of the cluster and extending along a thickness direction between opposing first and second major surfaces 52 and 53 of the cluster; and a common first material 71 substantially filling regions within the perimeter between the polymeric columns and across the thickness of the cluster, such that in a cross-section of the cluster in a plane substantially orthogonal to the thickness of the cluster, for at least each of a plurality of first polymeric columns 61 in the plurality of polymeric columns disposed adjacent the perimeter of the cluster, the first polymeric column has a pear shape having a wider portion 62 facing the perimeter and a narrower portion 63 facing away from the perimeter. An average viscosity of the polymeric columns can higher than an average viscosity of the first material by at least a factor of 1.2 or by a factor in a range described elsewhere herein. In some embodiments, the outermost perimeter 51 of the cluster 150 is polygonal. In some embodiments, for at least one polymeric column 160, 160′, 161, 161′ in the plurality of polymeric columns, the polymeric column includes a polymeric core 160a, 160a′ surrounded by a polymeric cladding 160b, 160b′ where a shape of an outer perimeter 260, 260′ of the polymeric cladding is substantially different than a shape of an outer perimeter 360, 360′ of the polymeric core as schematically illustrated in FIGS. 2B and 3B, for example. A substantially different shape should be understood to mean a substantial difference in geometry (e.g., as schematically illustrated in FIGS. 2B and 3B) beyond merely a difference in overall size. In some embodiments, the shape of the outer perimeter 260 of the polymeric cladding 160b is a pear shape having a wider portion facing the perimeter of the cluster and a narrower portion facing away from the perimeter of the cluster. In some embodiments, the shape of the outer perimeter 260 of the polymeric cladding 160b is a pear shape and the shape of the outer perimeter 360 of the polymeric core 160a is substantially circular. In some embodiments, in a cross-section of the cluster in a plane (xy-plane) substantially orthogonal to the thickness direction (z-direction), the cluster has a total area A1, and the polymeric columns has a total area A2, where A2/A1≥0.5 or A2/A1 can be in a range described elsewhere herein.

In some embodiments, a cluster 150, 150′ includes a plurality of substantially parallel polymeric columns 60, 160, 160′ disposed inside an outermost perimeter 51, 51′ of the cluster and extending along a thickness direction (z-direction) between opposing first and second major surfaces 52 and 53 of the cluster where each polymeric column includes a polymeric core 60a, 160a, 260a surrounded by a polymeric cladding 60b, 160b, 260b; and a common first material 170, 170′ substantially filling regions within the perimeter between the polymeric columns and across the thickness of the cluster. In some embodiments, for at least each of a plurality of first polymeric columns 161, 162 in the plurality of polymeric columns, a shape of an outer perimeter 260, 260 of the polymeric cladding is substantially different than a shape of an outer perimeter of the polymeric core (see, e.g., FIGS. 2B, 3B and 11). In some embodiments, for at least one first polymeric column 161, the shape of the outer perimeter 260 of the polymeric cladding is a pear shape and the shape of the outer perimeter 360 of the polymeric core 160a is substantially circular (see, e.g., FIG. 2B).

The polymeric columns 60, 160, 160′ can be optically transparent (e.g., having an average optical transmittance in a wavelength range of 420 nm to 680 nm of greater than 50%, or 60%, or 70% for light incident on the columns in a direction along a length of the columns). The material 70, 170, 170′ can be a light absorbing material. For example, the first material can include dye(s) and/or pigment(s) to absorb light. FIG. 4 is a schematic cross-sectional view of light absorbing polymeric material 30, according to some embodiments, which may correspond to material 70, 170, or 170′. In some embodiments, the material 30 includes a plurality of light absorbing particles 31 dispersed in an optically transparent binder 32. A polymeric material is a material including a continuous phase of organic polymer, unless indicated differently. A polymeric material may include inorganic material in a polymer matrix, for example. The light absorbing polymeric material 30 includes a plurality of light absorbing particles 31 dispersed in an optically transparent binder 32. In this context, a particle 31 may be a dye molecule, for example, or a pigment particle, for example. The light absorbing particles 31 may also partially reflect and/or diffuse light in addition to absorbing light (e.g., at least one wavelength in a visible range of 400 nm to 700 nm). In some embodiments, the light absorbing particles includes dark pigments or dark dyes such as black or gray pigments or dyes: metal such as aluminum, silver, etc.: dark metal oxides: or a combination thereof. Suitable light absorbing particles 31 include carbon black. Other suitable dyes and pigments may include, for example, one or more of Disperse Blue 60 (C₂₀H₁₇N₃O₅; CAS Number 12217-80-0): Pigment Yellow 147 (C₃₇H₂₁N₅O₄: CAS Number 4118-16-5): red azo dyes such as Red Dye 40 (C₁₈H₁N₂Na₂O₈S₂: CAS Number 25956-17-6): anthraquinone dyes pr pigments such as Solvent Yellow 163 (C₂₆H₁₆O₂S₂: CAS Number 13676-91-0), Pigment Red 177 (C₂₈H₁₆N₂O₄: CAS Number 4059-63-2), and Disperse Red 60 (C₂₀H₁₃NO₄: CAS Number 12223-37-9): perylene dyes or pigments such as Pigment Black 31 (C₄₀H₂₆N₂O₄: CAS Number 67075-37-0), Pigment Black 32 (C₄₀H₂₆N₂O₆: CAS Number 83524-75-8), and Pigment Red 149 (C₄₀H₂₆N₂O₄: CAS Number 4948-15-6); and the blue, yellow, red and cyan dyes PD-325H. PD-335H, PD-104 and PD-318H, respectively, available from Mitsui Fine Chemicals. Tokyo Japan. In some cases, a mixture of such dyes or pigments may be used to achieve optical absorption throughout a desired wavelength range (e.g., a visible wavelength range extending at least from 420 nm to 680 nm). In some embodiments, the light absorbing particles 31 include one or more of a light absorbing pigment, a light absorbing dye, and a carbon black.

In some embodiments, each of the plurality of polymeric columns 60, 160, 160′ is formed from a thermoplastic and the material 70, 170, 170′ is a thermoplastic material. In some embodiments, at least one of the plurality of polymeric columns 60, 160, 160′ and the material 70, 170, 170′ (e.g., corresponding to the binder 32 of the material 30) includes one or more of a polycarbonate, a polyester, an acrylic, a polyethylene terephthalate (PET), a polymethylmethacrylate (PMMA), a polyethylene naphthalate (PEN), a polybutylene terephthalate (PBT), polytrimethyleneterephthalate (PTT), a polyphenylene sulphone (PPSU), a polyether sulphone (PES), a polyphenylene sulfide (PPS), a polyetherimide (PEI), a sulfonated polysulfone (SPSU), polypropylene, a polyethylene (PE), a low density polyethylene (LDPE), an expanded polypropylene (EPP), a polylactide (PLA), a cyclic olefin, a polyurethane, a cellulose acetate (CA), a cellulose acetate butyrate (CAB), a cellulose acetate propionate (CAP), a styrene-butadiene-styrene (SBS), a styrene-ethylene-butadiene-styrene (SEBS), a nylon (also known as a polyamide (PA)), a polyurea, a rayon, a polyvinyl chloride (PVC), a polyvinylidene chloride (PVDC), a polybutylene (PB), a polymethyl pentane (e.g., TPX), a polytene, a polynorbornene, a polyvinyl alcohol (PVOH), a polyvinyl acetate (PVA), a polyaramid, a meta-aramid, a polybenzoxazole (PBO), a polybenzimidazole (PBI), a polyhydroquinone-diimidazopyridine (PIPD), a thermotropic liquid crystalline polymer (TLCP), and any copolymers thereof. LDPE is a grade of polyethylene characterized by a density in a range of about 910 to 940 kg/m³ or about 917 to 930 kg/m³. Suitable polyesters include polyethylene terephthalate (PET), polyethylene naphthalate (PEN), glycol-modified PET (PETg), and coPEN (copolyethylene naphthalate terephthalate copolymer), for example. Suitable PET can be obtained from Nan Ya Plastics Corporation. America (Lake City. SC), for example, PETg can be described as PET with some of the glycol units of the polymer replaced with different monomer units, typically those derived from cyclohexanedimethanol. PETg can be made by replacing a portion of the ethylene glycol (e.g., about 15 to about 60 mole percent or about 30 to about 40 mole percent) used in the transesterification reaction producing the polyester with cyclohexanedimethanol, for example. Suitable PETg include Copolyester 14285 and GN071, both available from Eastman Chemical Company (Kingsport, TN). PEN and coPEN can be made as described in U.S. Pat. No. 10,001,587 (Liu), for example. Other suitable polyesters include OKP-1 available from Osaka Gas Chemicals Co., Ltd. (Osaka, Japan), for example.

In some embodiments, the columns 60, 160, 160′ includes a polymeric core surrounded by a polymeric cladding (e.g., along each cross-section along a length of the columns). Suitable materials for the cladding include PMMA or fluoropolymer, for example. Suitable fluoropolymers include a terpolymer of hexafluoropropylene, tetrafluoroethylene and ethylene (e.g., DYNEON HTE available from 3M Company, St. Paul, MN) and a terpolymer of tetrafluoroethylene, hexafluoropropylene and vinylidene fluoride (e.g., DYNEON THV available from 3M Company, St. Paul, MN), for example.

In some embodiments, the (e.g., polygonal) cluster is free-standing and self-supporting. That is, the cluster, according to some embodiments, may be sufficiently wide and/or formed of materials having a sufficiently high modulus, for example, that the cluster does not need to be supported by a substrate or substrates in order for the cluster to maintain its shape. In some embodiments, a largest lateral dimension (largest dimension in a direction orthogonal to the length of the cluster) is at least 5, 10, 15, or 20 microns. The largest lateral dimension can be up to 2000, 1000, 700, or 500 microns, for example. In some embodiments, the cluster is formed via extrusion which can result in a large length of the cluster. The cluster may have a length greater than 1, 10, 100, or 1000 mm, for example. In some embodiments, an extruded cluster is cut to provide a cluster with a shorter length which may be referred to as a thickness of the cluster. The cluster may have a thickness less than 1, 0.5, 0.4, 0.35, 0.3, or 0.25 mm, for example. The thickness can be at least 10, 20, 50, or 100 microns, for example. The total number of columns in the cluster can be at least 5, 10, 15, or 20, for example. The total number of columns can be up to 500, 300, 100, or 50, for example.

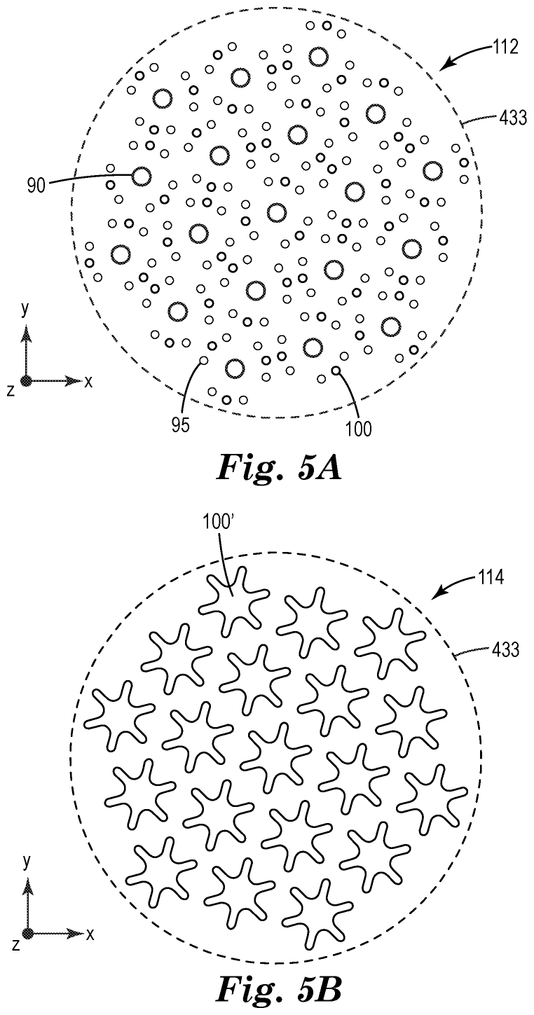

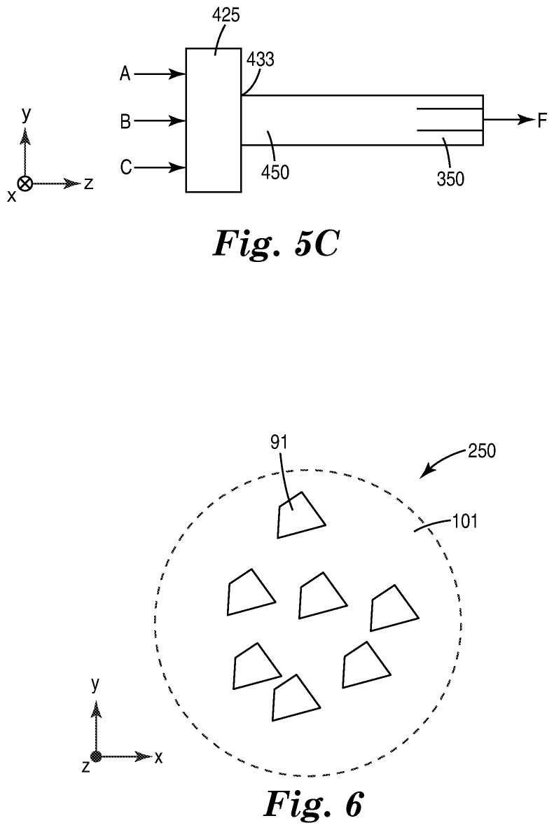

As is known in the art, bicomponent fibers, multi-component fibers, core-sheath fibers and island-in-the-sea fibers can be made by fiber melt-spinning, for example, which may be described as a form of extrusion where a spinneret is used to form continuous filaments. Such fibers are generally known in the art and are described in U.S. Pat. No. 4,768,857 (Sakunaga et al.): U.S. Pat. No. 5,702,658 (Pellegrin et al.): U.S. Pat. No. 6,465,094 (Dugan): U.S. Pat. No. 7,622,188 (Kamiyama et al.), for example. In some embodiments, the cluster 50, 150, 150′ can be formed by coextrusion of the columns 60, 160, 160′ and the material 70, 170, 170′. The columns 60, 160, 160′ embedded in the material 70, 170, 170′ can be formed via coextrusion using a die including a plurality of stacked plates to define flow channels through the die. FIGS. 5A-5B are schematic plan views of portions of two plates 112, 114 of a suitable die that can define a cluster, according to some embodiments. The plates can each include an array of the portions depicted in FIGS. 5A-5B to define a plurality of clusters. Each cluster may be extruded through a substantially round die exit opening 433 schematically illustrated in FIGS. 5A-5B by a dashed line corresponding to the opening and also schematically illustrated in FIG. 5C. Substantially round first columns 90 and second columns 100 are defined by plate 112. The die can be configured to join the second columns 100. Plate 114 includes openings 100′ that allow the material of the second columns 100 to flow toward one another such that the second columns are joined in the die (e.g., a plurality of the second columns 100 can be joined in each opening 100″: subsequent plates can be included to join the flows from the openings 100′). The flow of the material 100 can result in at least some of the columns 90 becoming substantially polygonal. FIG. 6 is a schematic cross-sectional view of a cluster 250, which may correspond to cluster 50, 150, or 150′, where the columns 91 are substantially polygonal, according to some embodiments. The cluster 250 may include other columns which have a shape other than polygonal (see, e.g., FIG. 2A). In some embodiments, the flow of the material 100 can result in at least some of the columns 90 becoming pear shaped.

In some embodiments, a method of making a cluster 250 includes: extruding a plurality of substantially round first columns 90 comprising a core material along substantially a same first direction (z-direction): extruding one or more second columns 100 including a base material (e.g., corresponding to material 70, 170, 170′) along the first direction; and joining the one or more second columns 100 along the first direction. The one or more second columns 100 can be at least 2, 4, or 6 second columns, for example. In some embodiments, the joining causes (at least some of) the substantially round first columns 90 to become substantially polygonal first columns 91 embedded in a common matrix 101 comprising the base material. In some such embodiments, or in other embodiments, the joining causes (at least some of) the substantially round first columns 90 to become pear shaped first columns (see, e.g., FIGS. 2A, 2B and 7) embedded in a common matrix 101 comprising the base material. The first columns 91 can include a core surrounded by a cladding where the cladding is extruded through openings 95 defined in the plate 112, for example. The method can further include pulling the extruded first and second columns along the first direction. This can result in a tensile stress applied to the first and second columns which can aid in shaping the first columns into polygonal and/or pear shaped columns. In some embodiments, the joining causes the substantially round first columns 90 to become substantially polygonal first columns 91 embedded in the common matrix 101 at least in part due to the core and base materials having different viscosities and/or at least in part due to a total area of the first columns comprising a substantial fraction of a total area of the cluster in a cross-section substantially orthogonal to the first direction. A viscosity of the core material can be higher than a viscosity of the base material by at least a factor of 1.2, or 1.25, or 1.3, or 1.35, or 1.4, or 1.45, or 1.5, or 1.55, or 1.6, or 2, or 2.5, or 3 as described further elsewhere herein. In some embodiments, in a cross-section of the cluster in a plane (xy-plane) substantially orthogonal to the first direction, the cluster has a total area A1, and first columns have a total area A2, where A2/A1≥0.5, or 0.55, or 0.6, or 0.65, or 0.7, or 0.75, or 0.8 as described further elsewhere herein. In some embodiments, the joining causes the substantially round first columns 90 to become substantially polygonal first columns 91 embedded in the common matrix 101 at least in part due to the core and base materials having different surface tensions. The ratio of surface tensions of the core and base materials can be as described elsewhere herein. The cluster 250 can have a substantially circular outermost perimeter as schematically illustrated in FIG. 6 (see also FIGS. 3A, 10, 11, for example) or a substantially polygonal outermost perimeter (see, e.g., FIGS. 2A, 7 and 9).

FIG. 5C schematically illustrates extruding a molten stream 450 through a die 425 which may include the plates 112 and 114 of FIGS. 5A-5B and may have a substantially round die exit opening 433. Materials A, B, and C are schematically illustrated as flowing into the die 425. Material A can correspond to the columns or cores of the columns and Material B can correspond to the base material surrounding the columns. Material C is optional and can correspond to claddings formed around the cores of Material A. The molten stream 450 has a substantially round perimeter upon exiting the opening 433 but the perimeter can, according to some embodiments, become substantially polygonal as the molten stream is cooled (e.g., by exposing the stream to ambient conditions outside the die 425) to provide the cluster 350 (e.g., corresponding to cluster 150). It has been found that extruding and cooling the molten stream can cause the perimeter to become polygonal at least in part due to one or more of: the columns having a higher average viscosity than the base material: the columns having a higher average surface tension than the base material: pulling the cluster 350 (via force F schematically illustrated in FIG. 5C) to apply tension to the molten stream; and/or a total area of the columns being a substantial fraction of a total area of the cluster 350 in a transverse cross-section (e.g., in x-y plane). Without intending to be limited by theory, it is believed that, in some embodiments, as the molten stream cools and transitions from liquid to solid, the viscosity and/or surface tension difference between the columns and base material drives the shape of the perimeter to a substantially polygonal shape, which may be generally defined by the arrangement of columns in the melt stream, as the cluster is pulled along the first direction.

In some embodiments, a method of making a cluster (e.g., 150) includes extruding a molten stream through a substantially round die exit opening 433 and cooling the molten stream to provide the cluster 350. Extruding the molten stream includes extruding a plurality of first columns 90 along substantially a same first direction (e.g., z-direction) where the plurality of first columns 90 has a first average viscosity; and extruding a base material along the first direction where the base material substantially fills regions between the first columns (e.g., through openings 100, 100′) and has a second average viscosity. In some embodiments, extruding and cooling the molten stream causes a perimeter of the cluster becomes substantially polygonal (e.g., corresponding to perimeter 51 schematically illustrated in FIG. 2A or to the substantially polygonal perimeters shown in FIGS. 7 and 9) at least in part due to the first average viscosity being higher than the second average viscosity. In some embodiments, extruding and cooling the molten stream 450 causes a perimeter of the cluster becomes substantially polygonal at least in part due to the first columns 90 and the base material having different average surface tensions. The ratio of average viscosities and/or average surface tensions can be in any of the ranges described elsewhere herein. For example, in some embodiments, the first average viscosity is higher than the second average viscosity by at least a factor of 1.2, or 1.25, or 1.3, or 1.35, or 1.4, or 1.45, or 1.5, or 1.55, or 1.6, or 2, or 2.5, or 3. In some embodiments, the method further includes pulling the cluster 350 along the first direction while extruding the molten stream 450. In some embodiments, extruding and cooling the molten stream causes a perimeter of the cluster 350 to become substantially polygonal at least in part due to a tension applied (e.g., via the force F) to the cooling molten stream from pulling the cluster along the first direction. In some embodiments, extruding the base material along the first direction includes: extruding a plurality of second columns 100 along the first direction where the second columns comprise the base material; and joining the second columns 100 (e.g., via plate 114) so that the base material substantially fills regions between the first columns. In some embodiments, in a cross-section of the cluster in a plane (xy-plane) substantially orthogonal to the first direction, the cluster has a total area A1, and the first columns have a total area A2, where A2/A1≥0.5 or A2/A1 can be in another range described elsewhere herein (e.g., A2/A2 can be at least 0.55, or 0.6, or 0.65, or 0.7, or 0.75, or 0.8). In some embodiments, extruding and cooling the molten stream causes a perimeter of the cluster becomes substantially polygonal at least in part due to A2/A1 being no less than 0.7, for example, or A2/A1 being in another range described elsewhere herein.

### EXAMPLES

### Example 1A

A plurality of clusters was made using a 19-island clad-island-sea die with funnel plate. The 19 islands of each cluster were arranged in a hexagonal pattern. The die had 156 round orifices with a diameter of 350 micrometers. The island material was PEN with an intrinsic viscosity of 0.48: the clad material was HTE fluoropolymer (available from 3M Company (St. Paul, MN) under the DYNEON tradename) with a 94 melt flow index (MFI); and the sea material was PETg (copolyester 14285 available from Eastman Chemical Company, Kingsport, TN). The process conditions were as indicated in the following tables:

| | | Extruder | | | | |
|---|---|---|---|---|---|---|
| | Extruder | Loop | Pump | Pump | Volume | Pump |
| | Temp. | Pressure | Size | Speed | Ratio | Pressure |
| | (° C.) | (Psi) | (cc/rev) | (rpm) | (%) | (Psi) |
| Island Melt | 300 | 800 | 3 | 10.6 | 70 | 2760 |
| Train | | | | | | |
| Clad Melt | 260 | 1000 | 1.168 | 5.6 | 15 | 1220 |
| Train | | | | | | |
| Sea Melt Train | 300 | 1200 | 1.168 | 5.6 | 15 | 260 |

| Die | | | | Winder | Target Fiber |
|---|---|---|---|---|---|
| Temperature | | Spin | Metering | Speed | Diameter |
| (° C.) | Quench | Finish | Godet | (m/min) | (μm) |
| 285 | No | Yes | No | 90 | 55 |

The clusters had an outermost perimeter having a substantially hexagonal shape with some minor rounding of the sides and corners of the hexagon. FIG. 9 shows a cross-section of a cluster of Example 1A. A ratio of a total area of the columns to a total area of the cluster in a transverse cross-section was about 0.85.

### Example 1B

A plurality of clusters was made as described for Example 1A except that the clad material was PMMA (Optical SUPURE 8N available from Evonik Cryo LLC, Parsippany, NJ) and the process conditions were as indicated in the following tables:

| | | Extruder | | | | |
|---|---|---|---|---|---|---|
| | Extruder | Loop | Pump | Pump | Volume | Pump |
| | Temperature | Pressure | Size | Speed | Ratio | Pressure |
| | (° C.) | (Psi) | (cc/rev) | (rpm) | (%) | (Psi) |
| Island Melt | 300 | 800 | 3 | 10.6 | 70 | 2554 |
| Train | | | | | | |
| Clad Melt | 260 | 1000 | 1.168 | 5.6 | 15 | 1270 |
| Train | | | | | | |
| Sea Melt Train | 270 | 1000 | 1.168 | 5.6 | 15 | 490 |

| Die | | | | Winder | Target Fiber |
|---|---|---|---|---|---|
| Temperature | | Spin | Metering | Speed | Diameter |
| (° C.) | Quench | Finish | Godet | (m/min) | (μm) |
| 285 | No | Yes | No | 90 | 55 |

The clusters had an outermost perimeter having a substantially round shape. Compared to Example 1A, the sea polymer was cooler and the viscosity difference between the sea and the average viscosity of the core and cladding was smaller. FIG. 10 shows a cross-section of a cluster of Example 1B. Some cracks are visible from cutting the cluster. A ratio of a total area of the columns to a total area of the cluster in a transverse cross-section was about 0.85.

### Example 2

A plurality of clusters was made using a 37-island clad-island-sea die with funnel countersink and a single orifice having a 1 mm diameter. The island material was OKP-1 available from Osaka Gas Chemicals Co., Ltd. (Osaka, Japan); the clad material was THV fluoropolymer (available from 3M Company (St. Paul, MN) under the DYNEON tradename) with an 86 MFI; and the sea material was PETg (copolyester 14285 available from Eastman Chemical Company, Kingsport, TN). The process conditions were as indicated in the following tables:

| | | Extruder | | | | |
|---|---|---|---|---|---|---|
| | Extruder | Loop | Pump | Pump | Volume | Pump |
| | Temp. | Pressure | Size | Speed | Ratio | Pressure |
| | (° C.) | (Psi) | (cc/rev) | (rpm) | (%) | (Psi) |
| Island Melt | 300 | 500 | 0.6 | 3.8 | 65 | 770 |
| Train | | | | | | |
| Clad Melt | 260 | 500 | 0.6 | 0.9 | 15 | 499 |
| Train | | | | | | |
| Sea Melt Train | 270 | 300 | 0.6 | 1.2 | 20 | 250 |

| Die | | | | Winder | Target Fiber |
|---|---|---|---|---|---|
| Temperature | | Spin | Metering | Speed | Diameter |
| (° C.) | Quench | Finish | Godet | (m/min) | (μm) |
| 285 | Water | No | No | 680 | 77 |

The columns formed a hexagonal packing within each cluster which affected the shapes of the perimeters of the clusters. The shapes of the perimeters ranged from roughly round to roughly hexagonal. FIG. 8 shows a cross-section of a cluster of Example 2. A ratio of an area of a smallest hexagon that surrounds the columns to a total area of cluster in a transverse cross-section was about 0.86, and a ratio of a total area of the columns to a total area of the cluster in a transverse cross-section was about 0.8, so a ratio of a total area of the columns to the area of a smallest hexagon that surrounds the columns was about 0.8/0.86 or about 0.93.

### Example 3A

A plurality of clusters was made as described for Example 2 except that the die had no funnel countersink, and the clad material was THV fluoropolymer (available from 3M Company (St. Paul, MN) under the DYNEON tradename) with a 120 MFI and the process conditions were as indicated in the following tables:

| | | Extruder | | | | |
|---|---|---|---|---|---|---|
| | Extruder | Loop | Pump | Pump | Volume | Pump |
| | Temperature | Pressure | Size | Speed | Ratio | Pressure |
| | (° C.) | (Psi) | (cc/rev) | (rpm) | (%) | (Psi) |
| Island Melt | 300 | 500 | 0.6 | 3.8 | 65 | 560 |
| Train | | | | | | |
| Clad Melt | 260 | 500 | 0.6 | 0.9 | 15 | 470 |
| Train | | | | | | |
| Sea Melt Train | 270 | 500 | 0.6 | 1.2 | 20 | 250 |

| Die | | | | Winder | Target Fiber |
|---|---|---|---|---|---|
| Temperature | | Spin | Metering | Speed | Diameter |
| (° C.) | Quench | Finish | Godet | (m/min) | (μm) |
| 285 | Water | No | No | 200 | 142 |

The clusters had an outermost perimeter having a hexagonal shape. Some of the islands were deformed and two islands on each of the six sides for the clusters had a pear shape. FIG. 7 shows a cross-section of a cluster of Example 3A. A ratio of a total area of the columns to a total area of the cluster in a transverse cross-section was about 0.8.

### Example 3B

A plurality of clusters was made as described for Example 3A except that the ratio of the three polymers was changed, the clad material was THV fluoropolymer (available from 3M Company (St. Paul, MN) under the DYNEON tradename) with a 240 MFI and the core material was PEN with an intrinsic viscosity of 0.48. The process conditions were as indicated in the following tables.

| | | Extruder | | | | |
|---|---|---|---|---|---|---|
| | Extruder | Loop | Pump | Pump | Volume | Pump |
| | Temperature | Pressure | Size | Speed | Ratio | Pressure |
| | (° C.) | (Psi) | (cc/rev) | (rpm) | (%) | (Psi) |
| Island Melt | 300 | 500 | 0.6 | 2 | 33 | 870 |
| Train | | | | | | |
| Clad Melt | 260 | 500 | 0.6 | 2 | 33 | 520 |
| Train | | | | | | |
| Sea Melt Train | 270 | 500 | 0.6 | 2 | 33 | 430 |

| Die | | | | Winder | Target Fiber |
|---|---|---|---|---|---|
| Temperature | | Spin | Metering | Speed | Diameter |
| (° C.) | Quench | Finish | Godet | (m/min) | (μm) |
| 285 | Water | No | No | 680 | 77 |

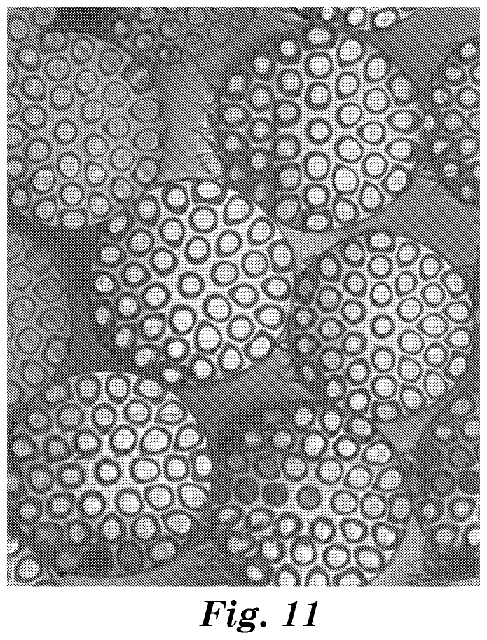

FIG. 11 shows a cross-section of clusters of Example 3B. Due at least in part to a total area ratio of the cores plus cladding to overall area being lower in this case (about 0.67), the clusters had a substantially round perimeter. Some of the columns had a pear shape. For example, some of the claddings (darker regions surrounding lighter cores) had a pear shaped outer perimeter.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially” with reference to a property or characteristic is not otherwise clear to one of ordinary skill in the art in the context in which it is used and described in the present description and when it would be clear to one of ordinary skill in the art what is meant by an opposite of that property or characteristic, the term “substantially” will be understood to mean that the property or characteristic is exhibited to a greater extent than the opposite of that property or characteristic is exhibited.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1-15. (canceled)

16. A polygonal cluster comprising:
a plurality of substantially parallel polymeric columns disposed inside an outermost polygonal perimeter of the polygonal cluster and extending along a thickness direction between opposing first and second major surfaces of the polygonal cluster; and
a common first material substantially filling regions within the polygonal perimeter between the polymeric columns and across the thickness of the polygonal cluster,
such that in a cross-section of the polygonal cluster in a plane substantially orthogonal to the thickness of the cluster, for at least each of a plurality of first polymeric columns in the plurality of polymeric columns disposed adjacent the perimeter of the cluster, the first polymeric column has a pear shape having a wider portion facing the perimeter and a narrower portion facing away from the perimeter.

17. The polygonal cluster of claim 16, wherein an average viscosity of the polymeric columns is higher than an average viscosity of the first material by at least a factor of 1.2.

18. The polygonal cluster of claim 16, wherein in a cross-section of the polygonal cluster in a plane substantially orthogonal to the thickness direction, the cluster comprises a closed outermost polygonal perimeter and a total area A1, and the polymeric columns comprise a total area A2, A2/A1≥0.5.

19. The polygonal cluster of claim 16, wherein an average surface tension of the polymeric columns is higher than an average surface tension of the first material.

20. The polygonal cluster of claim 16, wherein the polymeric columns are optically transparent, and the first material is optically absorbing.

21. The polygonal cluster of claim 20, wherein the first material comprises a plurality of light absorbing particles dispersed in an optically transparent binder.

22. A cluster comprising:
a plurality of substantially parallel polymeric columns disposed inside an outermost perimeter of the cluster and extending along a thickness direction between opposing first and second major surfaces of the cluster; and
a common first material substantially filling regions within the perimeter between the polymeric columns and across the thickness of the cluster, such that in a cross-section of the cluster in a plane substantially orthogonal to the thickness of the cluster, for at least each of a plurality of first polymeric columns in the plurality of polymeric columns disposed adjacent the perimeter of the cluster, the first polymeric column has a pear shape having a wider portion facing the perimeter and a narrower portion facing away from the perimeter, wherein an average viscosity of the polymeric columns is higher than an average viscosity of the first material by at least a factor of 1.2.

23. The cluster of claim 22, wherein for at least one polymeric column in the plurality of polymeric columns, the polymeric column comprises a polymeric core surrounded by a polymeric cladding, a shape of an outer perimeter of the polymeric cladding being substantially different than a shape of an outer perimeter of the polymeric core.

24. The cluster of claim 22, wherein an average surface tension of the polymeric columns is higher than an average surface tension of the first material.

25. The cluster of claim 22, wherein the polymeric columns are optically transparent, and the first material is optically absorbing.

26. The cluster of claim 25, wherein the first material comprises a plurality of light absorbing particles dispersed in an optically transparent binder.

27. A cluster comprising:
a plurality of substantially parallel polymeric columns disposed inside an outermost perimeter of the cluster and extending along a thickness direction between opposing first and second major surfaces of the cluster, each polymeric column comprising a polymeric core surrounded by a polymeric cladding; and
a common first material substantially filling regions within the perimeter between the polymeric columns and across the thickness of the cluster,
wherein for at least each of a plurality of first polymeric columns in the plurality of polymeric columns, a shape of an outer perimeter of the polymeric cladding is substantially different than a shape of an outer perimeter of the polymeric core.

28. The cluster of claim 27, wherein for at least one first polymeric column, the shape of the outer perimeter of the polymeric cladding is a pear shape and the shape of the outer perimeter of the polymeric core is substantially circular.

29. The cluster of claim 27, wherein an average surface tension of the polymeric columns is higher than an average surface tension of the first material.

30. The cluster of claim 27, wherein the polymeric columns are optically transparent, and the first material is optically absorbing.

31. The cluster of claim 30, wherein the first material comprises a plurality of light absorbing particles dispersed in an optically transparent binder.
